(19) United States
(12) Patent Application Publication
(10) Pub. No.: US 2001/0051912 A1
(43) Pub. Date: Dec. 13, 2001

(54) Commodity ordering method and commodity ordering system

(75) Inventors: Hisashi Tanaka, Tokyo (JP); Katsumi Sasaki, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/875,530

(22) Filed: Jun. 6, 2001

(30) Foreign Application Priority Data
Jun. 7, 2000 (JP) 2000-170883

(51) Int. Cl. G06F 17/60

(52) U.S. Cl. 705/37; 705/36; 705/26

(57) ABSTRACT

When a commodity is ordered at a terminal, customer information stored in advance is displayed on a terminal, and the order is accepted when the displayed customer information is designated. Where the customer information stored in advance includes a plurality of pieces of information for each item, one of the pieces of customer information is selected, and the selected customer information is used to accept the order. When it is tried to use a customer information different from the customer information displayed on the terminal to order a commodity, if desired customer information is entered, then the entered customer information is used to accept the order. The entered customer information is stored as additional information to the customer information stored in advance and is displayed on the terminal and used as an object of selection upon later ordering.

### BACKGROUND OF THE INVENTION

1. Field of the Invention

This invention relates to a commodity ordering method and a commodity ordering system for online shopping which is performed over a network such as the Internet, and more particularly to a commodity ordering method and a commodity ordering system for use to order a commodity after customer information is registered.

2. Description of the Related Art

Recently, the Internet and personal computers are becoming prevalent rapidly, and an individual can establish connection to the Internet readily at any time and at any place. Incidentally, a sharp increase is seen in the number of companies, organizations and so forth which set up a homepage on the Internet and use the homepage to provide information or sell commodities and so forth.

In sales of commodities and so forth using a homepage, i.e., in online shopping, a commodity, a service or the like can be readily purchased in a home or a like place. Therefore, the number of users thereof tends to be increased.

In common online shopping, when a user attempt to purchase a commodity or the like, the user first selects a desired commodity or service from among commodities, services or the like displayed on a terminal such as a personal computer and decides to purchase the commodity or service. Thereafter, the user enters customer information including the name, address, telephone number, E-mail address and so forth and selects the method of payment of the purchase-money.

After the user confirms the commodity to be purchased and the method of payment determined by the method described above as well as contents of the customer information, the user orders the commodity or the like.

In the online shopping described above, a page for entering the customer information including the name, address, telephone number, E-mail address and so forth, a page for selecting a method of payment of purchase-money and a page for user to confirm the determined commodity to be purchased, method of payment and customer information are transmitted from a company or the like which provides commodities or the like to the terminal of the user over a network. The user may enter the above-described information into the terminal.

In order to save the time required to input customer information when a commodity is ordered, a commodity ordering method has been proposed wherein customer information entered for ordering of a commodity is stored in a corresponding relationship to an identifier for identification of the user into a server of a company or the like which provides commodities or the like and then, when an order for a commodity is received from the user corresponding to the customer information stored in the server, the customer information stored in the server is used to accept the order for a commodity.

When a user tries to purchase a commodity or the like for the first time, the user enters customer information including the name, address, telephone number, E-mail address and so forth to a terminal such as a personal computer. When the customer information is entered, the entered customer information is stored in a corresponding relationship to an identifier for identification of the user into a server of a company which provides commodities. The identifier is allocated to the terminal when the user uses the terminal to access a homepage of the company or the like and is stored into the terminal of the user.

Thereafter, if the user accesses the homepage of the company or the like in order to order a commodity or the like and designates a desired commodity, then the a request to order the designated commodity is transmitted to the server of the company or the like together with the identifier of the user. Then, customer information corresponding to the identifier transmitted from the terminal is searched out from within customer information stored in the server, and the searched out customer information is used to determine a destination of delivery of the commodity, a method of payment of the purchase-money and other necessary items and then the order is accepted.

Since customer information of a user who has ordered a commodity once is stored in a corresponding relationship to an identifier for identification of the user in a server of a company or the like which provides commodities or the like in this manner, only if the user designates a desired commodity, then the user can order the commodity or the like to the company.

In such a conventional commodity ordering method as described above, customer information stored once is used to order a commodity or the like. However, if a user forgets its stored contents, then a trouble may occur. In a case, for example, wherein a user forgets, while the user has stored, as its customer information, use of a particular credit card as a method of payment of purchase-money, which one of credit cards owned by the user should be used, the purchase-money may possibly be paid from an unintended account of the user. Further, if the user forgets a stored destination of delivery of a commodity, then the user cannot discriminate to where an ordered commodity is to be delivered.

Furthermore, an order based on information different from stored customer information such as, for example, a different destination of delivery or a different method of payment of purchase-money is not permitted. Therefore, there is a problem that, when a user tries to order based on information different from stored customer information, the user must enter all necessary customer information again and this requires much time.

### SUMMARY OF THE INVENTION

It is an object of the present invention to provide a commodity ordering method and a commodity ordering system by which a user can confirm customer information stored for ordering of a commodity and can order a commodity without requiring much time even when the user uses customer information different from the stored customer information.

According to the present invention, when a commodity is ordered at a terminal, customer information stored in advance is displayed on a terminal, and the order is accepted when the displayed customer information is designated. Where the customer information stored in advance includes a plurality of pieces of information for each item, one of the pieces of customer information is selected, and the selected customer information is used to accept the order. When it is tried to use a customer information different from the customer information displayed on the terminal to order a commodity, if desired customer information is entered, then the entered customer information is used to accept the order. The entered customer information is stored as additional information to the customer information stored in advance and is displayed on the terminal and used as an object of selection upon later ordering.

In this manner, when a commodity is ordered at a terminal, the customer information stored in advance is displayed, and if desired customer information is selected from within the displayed customer information or new customer information is entered, then the selected or entered customer information is used to accept the order. Therefore, upon ordering of a commodity, the stored customer information can be confirmed, and customer information to be used can be set each time a commodity is ordered.

The above and other object, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram showing an embodiment of a commodity ordering system of the present invention;

FIG. 2 is a flow chart illustrating a commodity ordering method by the commodity ordering system shown in FIG. 1;

FIG. 3 is a schematic view showing a form for new customer information registration used in the commodity ordering system shown in FIG. 1;

FIG. 4 is a schematic view showing a customer information display page used in the commodity ordering system shown in FIG. 1; and

FIG. 5 is a view showing a record table of a customer information database shown in FIG. 1.

### DETAILED DESCRIPTION OF THE PREFERRED EMBODIMENT

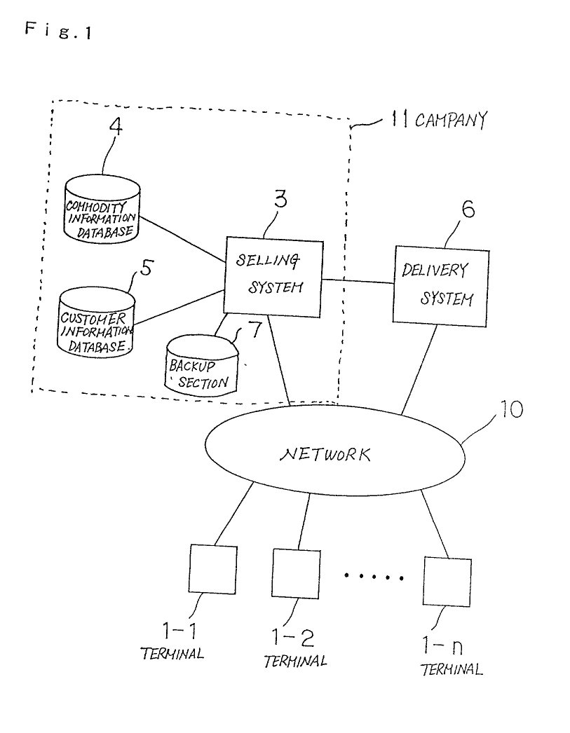

The commodity ordering system of the present embodiment comprises, as shown in FIG. 1 a plurality of terminals 1-1 to 1-n which may each be an information processing devices such as a personal computer operated by a user, selling system 3 owned by company 11 as commodity provision means serving as the providing side of commodities or services, for providing online shopping to terminals 1-1 to 1-n over network 10, commodity information database 4 serving as commodity information storage means for storing information on commodities to be handled in the online shopping, customer information database 5 as customer information storing means for string customer information including the name, address, telephone number, E-mail address and so forth of users, and delivery system 6 for managing arrangements, adjustment and shipment associated with delivery of a commodity or the like in accordance with an instruction from selling system 3.

Terminals 1-1 to 1-n have a function of accessing commodity information and so forth provided on network 10 from selling system 3 and displaying the commodity information and so forth on a screen. Terminals 1-1 to 1-n further have a function of transmitting information entered into terminals 1-1 to 1-n in accordance with a page displayed on the screen by a user to selling system 3 over network 10 and can order a commodity through a purchasing procedure in the online shopping.

Selling system 3 comprises an information processing device such as a work station server or a storage and so forth, and has a Web management function, a shop function, an order management, customer management function, and an order receipt, arrangements, adjustment, delivery instruction function. More particularly, selling system 3 provides information regarding commodities stored in commodity information database 4 to terminals 1-1 to 1-n over network 10. Further, selling system 3 receives information entered into terminals 1-1 to 1-n by users over network 10 and transmits a commodity order receipt, arrangements, adjustment, shipment instruction and so forth to delivery system 6 based on the received information. Furthermore, selling system 3 has functions of storing customer information entered into terminals 1-1 to 1-n by users in customer information database 5, checking whether or not such customer information is stored in customer information database 5 and, if the customer information is stored, acquiring the customer information from customer information database 5.

Delivery system 6 comprises an information processing device such as a workstation server or a storage and so forth and has a function of receiving ordering information from selling system 3 and managing shipment of commodities from arrangements thereof to delivery to designated destinations.

Company 11 may possibly include backup section 7 which has a functions of sale system 3 and stores information stored in selling system 3, commodity information stored in commodity information database 4 and customer information stored in customer information database 5.

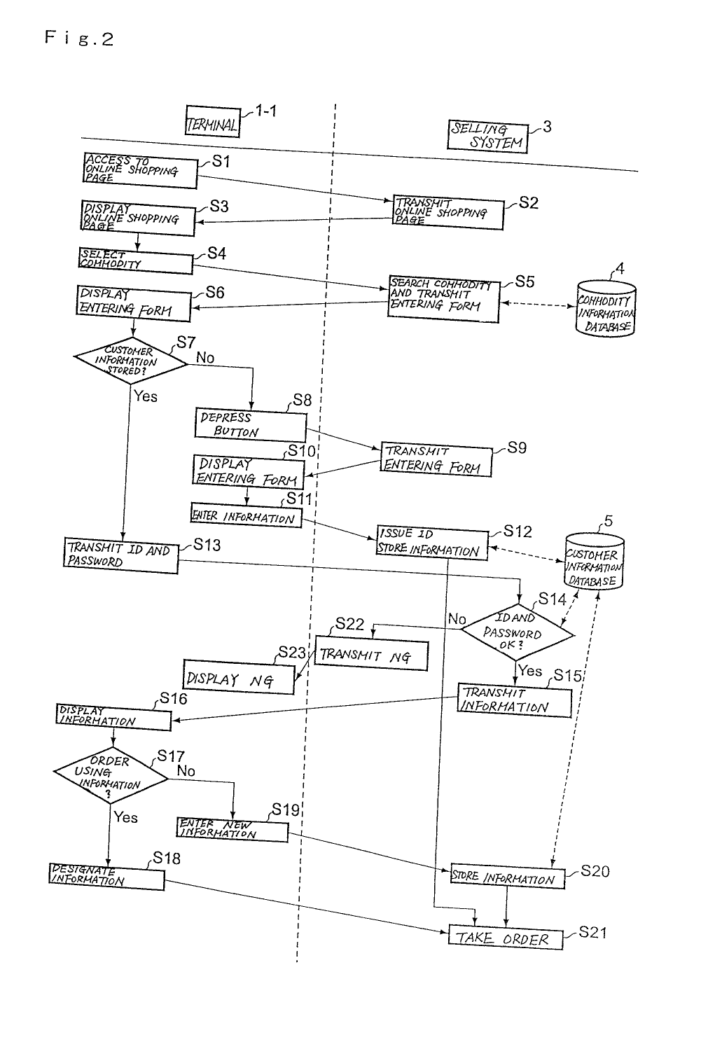

In the following, the commodity ordering method by the commodity ordering system having the configuration described above will be described with reference to FIG. 2 taking a case wherein a commodity is ordered from terminal 1-1 as an example.

If a request to access to a page for online shopping is issued from terminal 1-1 to selling system 3 over network 10 in order for a customer to perform online shopping in step S1, then a page for online shopping is transmitted from selling system 3 in step S2 and is displayed on the screen of terminal 1-1 in step S3.

If the user of terminal 1-1 looks at the page for online shopping and selects a desired commodity in step S4, then selling system 3 searches out the selected commodity from within commodity information database 4 and transmits a form for entering a customer ID and a password to terminal 1-1 in step S5. Here, the commodity selection is not limited to selection of a single commodity but allows selection of a plurality of commodities. When a plurality of commodities are to be selected, each time a commodity is selected, a notification of this may be sent to selling system 3, or after all of desired commodities are selected, a notification of this maybe sent to selling system 3.

The entering form for entering a customer ID and a password transmitted from selling system 3 is displayed on terminal 1-1 in step S6.

If the user of terminal 1-1 has not registered its customer information as yet, or in other words, if the user performs online shopping with selling system 3 for the first time in step S7, the user will depress a customer information registration request button displayed on the screen of terminal 1-1 in step S8.

When the customer information registration request button is depressed, a form for new customer information registration is transmitted from selling system 3 to terminal 1-1 in step S9.

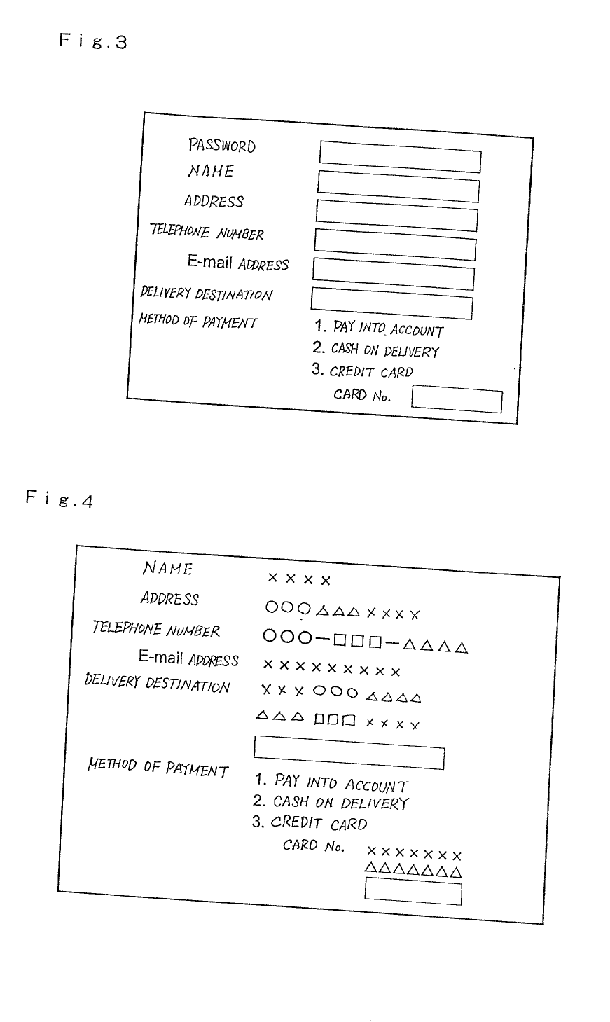

As shown in FIG. 3, the form for new customer information registration in the present embodiment allows entering of a desired password, the name, address, telephone number and E-mail address of a user, a delivery destination of a commodity and a method of payment of purchase-money. The user will enter unique information for each item. For the method of payment of purchase-money, the user can select one of methods by pay into account, cash on delivery and a credit card. For the payment by a credit card, the number of a desired credit card can be entered.

The form for new customer information registration transmitted from selling system 3 is displayed on terminal 1-1 in step S1. The user will enter customer information including a desired password, the name, address, telephone number and E-mail address of the user, a delivery destination of a commodity, a method of payment of purchase-money and so forth in accordance with the form displayed on terminal 1-1 and transmit the customer information in step S11.

The customer information transmitted from terminal 1-1 is received by selling system 3 and written as customer information to which a unique customer ID is allocated into customer information database 5 and then the customer ID is transmitted back to terminal 1-1 in step S12. Thereafter, the user will proceed with online shopping with selling system 3 using the customer ID allocated to the user and the password set by the user.

On the other hand, if the user has its customer information registered already, then the user will enter the customer ID given to the user formerly and the password set in advance by the user to the form and transmit the form to selling system 3 in step S13.

When selling system 3 receives the customer ID and the password, it discriminates whether or not the correspondence between the entered customer ID and password coincides with the correspondence between a customer ID and a password stored in customer information database 5 in step S14. If the two correspondences coincide with each other in step S14, then the customer information corresponding to the customer ID and the password is extracted from customer information database 5 and transmitted to terminal 1-1 in step S15.

The customer information transmitted from selling system 3 is displayed on the screen of terminal 1-1 in step S16, and the user will use the displayed customer information to determine whether or not a commodity should be ordered in step S17.

As seen in FIG. 4, the name, address, telephone number and E-mail address of the user, the delivery destination of a commodity and the method of payment of purchase-money stored in customer information database 5 are displayed on terminal 1-1. If a plurality of different pieces of information are stored for one item, then all stored pieces of information are displayed.

Where a plurality of pieces of information are displayed for an item, the user can select a desired one of the plurality of pieces of information.

Further, if the user wants to order a commodity using information different from the displayed information, then the user can enter new information and use the information to order a commodity.

If the user wants to use the customer information displayed on the screen of terminal 1-1 to order a commodity, the user will designate the displayed customer information in step S18. Here, if one item includes a single piece of information, then the user will designate the information. However, if one item includes a plurality of pieces of information, i.e., if a plurality of delivery destinations or a plurality of methods of payment, for example, are displayed, then the user will select a desired one of the pieces of information.

On the other hand, if the user wants to use information different from the customer information displayed on the screen of terminal 1-1 to order a commodity, i.e., if the user wants, for example, to have a commodity distributed to a delivery destination different from the delivery destination or destinations stored in customer information database 5 or to pay purchase-money by a method of payment different from the method of payment stored in customer information database 5, then the user will enter new information to the pertaining item and designate the same in step S19.

The information entered in step S19 is transmitted to selling system 3 and stored in customer information database 5 in step S20.

Thereafter, in step S21, selling system 3 uses the customer information designated in step S18 or step S19 to accept the order for the commodity selected in step S4. Consequently, the commodity is delivered to the desired delivery destination by delivery system 6.

On the other hand, if the result of the discrimination in step S14 is abnormal such as incoincidence of the passwords, then the information that the customer ID and the password are not correct is transmitted to terminal 1-1 in step S22, and terminal 1-1 displays the information transmitted thereto in step S23.

In the following, customer information stored in customer information database 5 will be described in detail.

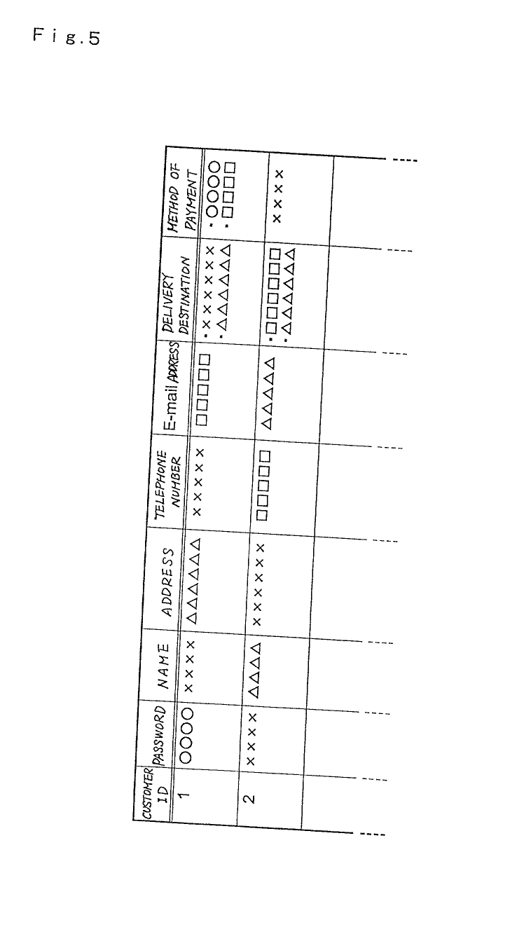

As seen in FIG. 5, customer information database 5 in the present embodiment has a customer ID set for each user therein. Further, customer information database 5 has the password, name, address, telephone number and E-mail address of a user as well as a delivery destination of a commodity and a method of payment of purchase-money set in a corresponding relationship to each customer ID therein, and the information entered in steps S11 and S19 illustrated in FIG. 2 is stored in the individual items. In particular, even when information other than information stored formerly is entered for an item in step S19, the newly entered information is additionally entered for the item. Thereafter, when customer information is displayed on the pertaining one of terminals 1-1 to 1-n, all information registered is displayed.

Customer information stored in customer information database 5 can be deleted by its user.

In step S18, the user can select desired information from all information displayed on terminal 1-1 to 1-n.

It is to be noted that, while, in the present embodiment, customer information stored in customer information database 5 is displayed at a time on the screen of terminal 1-1, the present invention is not limited to this, and the commodity ordering system may be configured otherwise such that such customer information is displayed for each item and the user designates with regard to the displayed information or enters new information.

Further, while a customer ID and a password are allocated to each user and used for identification of the user, the commodity ordering system maybe configured otherwise such that, when a user accesses a page for online shopping once, selling system 3 allocates an identifier to the terminal and, when the page for online shopping is thereafter accessed from the terminal, the identifier is transmitted to selling system 3 so that the user is identified from the identifier by selling system 3.

As described above, in the present embodiment, when a user performs online shopping for the first time, customer information of the user is stored in customer information database 5, and when the user thereafter performs online shopping again, the customer information stored in customer information database 5 is displayed on the screen of terminal 1-1 to 1-n. Therefore, when the user tries to order a commodity, the user can confirm the customer information of the user itself stored in customer information database 5.

On the other hand, when the user tries to use customer information different from the customer information stored in customer information database 5 to order a commodity, the user can enter new customer information, and the entered customer information is stored as additional information to the customer information of the user into customer information database 5 and is thereafter used as selectable customer information on terminal 1-1 to 1-n when the user tries to perform online shopping. Therefore, the user can designate customer information to be used for distribution of a commodity each time the user orders a commodity.

While preferred embodiments of the present invention have been described using specific terms, such description is for illustrative purposes only, and it is to be understood that change and variations may be made without departing from the sprit or scope of the following claims.

What is claimed is:

1. A commodity ordering method, comprising the steps of:
storing customer information entered in a plurality of terminals into commodity provision means connected to said terminals in advance;
designating a commodity provided by said commodity provision means using any of said terminals; and
displaying the customer information on said terminals by which the commodity has been designated.

2. A commodity ordering method according to claim 1, further comprising the steps of:
designating the customer information displayed on the terminal; and
taking an order for the commodity using the customer information.

3. A commodity ordering method according to claim 2, wherein the customer information includes a plurality of items, and the commodity ordering method further comprising the steps of:
designating the customer information for each of the items; and
taking the order for the commodity using the customer information.

4. A commodity ordering method according to claim 3, further comprising the step of
displaying the customer information for each of the items on the terminal.

5. A commodity ordering method according to claim 3, further comprising the step of
displaying a plurality of pieces of customer information for one of the items.

6. A commodity ordering method according to claim 4, further comprising the step of
displaying a plurality of pieces of customer information for one of the items.

7. A commodity ordering method according to claim 5, further comprising the steps of:
selecting a desired one of the pieces of information; and
taking the order for the commodity using the selected information.

8. A commodity ordering method according to claim 6, further comprising the steps of:
selecting a desired one of the pieces of information; and
taking the order for the commodity using the selected information.

9. A commodity ordering method according to claim 1, wherein the customer information includes a plurality of items, and the commodity ordering method further comprising the steps of:
designating the customer information displayed on the terminal or entering new customer information for each of the items; and
taking the order for the commodity using the customer information.

10. A commodity ordering method according to claim 9, further comprising the steps of:
storing the new customer information as additional information to the customer information stored in advance; and
displaying the customer information including the new customer information added thereto on the terminal when the commodity is ordered using the terminal.

11. A commodity ordering method according to claim 10, further comprising the steps of:
selecting desired information from within the customer information with regard to any item which includes the newly added customer information; and
taking the order for the commodity using the selected information.

12. A commodity ordering system, comprising:
a plurality of terminals;
customer information storage means for storing customer information designated by users who operate said terminals; and
commodity provision means connected to said terminals for providing commodities to said terminals and for extracting, when any of the commodities is ordered from any of said terminals, the customer information corresponding to the terminal at said customer information storage means and transmitting the extracted customer information to the terminal;
the terminal displaying the customer information transmitted thereto from said commodity provision means.

13. A commodity ordering system according to claim 12, wherein, when the customer information displayed on the terminal is designated, said commodity provision means takes an order for the commodity using the customer information.

14. A commodity ordering system according to claim 13, wherein the customer information includes a plurality of items, and said commodity provision means takes the order for the commodity using the customer information to accept the order for the commodity when the customer information is designated for each of the items.

15. A commodity ordering system according to claim 14, wherein said commodity provision means transmits the customer information for each of the items to the terminal, and the terminal displays the customer information transmitted thereto from said commodity provision means for each of the items.

16. A commodity ordering system according to claim 14, wherein the customer information includes a plurality of pieces of information for one of the items.

17. A commodity ordering system according to claim 15, wherein the customer information includes a plurality of pieces of information for one of the items.

18. A commodity ordering system according to claim 16, wherein said commodity provision means takes the order using desired information selected from among the pieces of information.

19. A commodity ordering system according to claim 17, wherein said commodity provision means takes the order using desired information selected from among the pieces of information.

20. A commodity ordering system according to claim 12, wherein the commodity information includes a plurality of items, and said commodity provision means takes the order for the commodity using, when the customer information displayed on the terminal is designated or new customer information is entered to the terminal for each of the items, the designated or entered customer information.

21. A commodity ordering system according to claim 20, wherein said commodity provision means stores the new customer information as additional information into said customer information storage means and displays, when any of the commodities is ordered at the terminal, the customer information including the new customer information added thereto on the terminal.

22. A commodity ordering system according to claim 21, wherein said commodity provision means takes the order using, for any item for which the new customer information is additionally stored, desired information selected from within the customer information.

23. A commodity ordering system according to claim 12, further comprising commodity information storage means for string information regarding the commodities provided from said commodity provision means.

24. A backup means for use with a commodity ordering system according to claim 12, wherein said backup means stores the customer information stored in said customer information storage means.

25. A backup means for use with a commodity ordering system according to claim 23, wherein said backup means stores the information stored in said commodity information storage means.

26. A selling system possessed by a company, an organization or the like which provides commodities in response to orders at a plurality of terminals for taking the order for the commodity, when any of the commodities is ordered at any of said terminals, using customer information designated by a user who operates the terminal, comprising:
means for causing, when the commodity is ordered at the terminal, the customer information to be displayed on the terminal.

27. A selling system according to claim 26, wherein said selling system takes the order for the commodity, when the customer information displayed on the terminal is designated, using the customer information.

28. A selling system according to claim 27, wherein the customer information includes a plurality of items, and when the customer information is designated for each of the items, said selling system takes the order for the commodity using the customer information.

29. A selling system according to claim 28, wherein said selling system causes the customer information to be displayed for each of the items on the terminal.

30. A selling system according to claim 28, wherein the customer information includes a plurality of pieces of information for one of the items.

31. A selling system according to claim 29, wherein the customer information includes a plurality of pieces of information for one of the items.

32. A selling system according to claim 30, wherein said selling system takes the order, when a desired one of the pieces of information is selected, using the selected piece of information.

33. A selling system according to claim 31, wherein said selling system takes the order, when a desired one of the pieces of information is selected, using the selected piece of information.

34. A selling system according to claim 27, wherein the customer information includes a plurality of items, and when the customer information displayed on the terminal is designated or new customer information is entered to the terminal for each of the items, said selling system takes the order for the commodity using the designated or entered customer information.

35. A selling system according to claim 34, wherein said selling system stores the new customer information as additional information to the customer information stored in advance and causes, when any of the commodities is ordered at the terminal, the customer information including the newly added customer information to be displayed on the terminal.

36. A selling system according to claim 35, wherein said selling system takes the order, for any item for which the new customer information is additionally stored, using desired information selected from within the customer information.

37. A backup means having a function of a selling system according to claim 26 and storing information stored in said selling system.
